(19) United States
(12) Patent Application Publication
(10) Pub. No.: US 2004/0069361 A1
(43) Pub. Date: Apr. 15, 2004

(54) Hose for conveying fluids containing hydrogen

(75) Inventors: Cyrielle Cheng, Saint-Jean De Monts (FR); Pierre Milhas, Vitry Le Francois (FR)

Correspondence Address: YOUNG & THOMPSON, 745 SOUTH 23RD STREET 2ND FLOOR, ARLINGTON, VA, 22202

(73) Assignee: NOBEL PLASTIQUES, MAROLLES (FR)

(21) Appl. No.: 10/679,260

(22) Filed: Oct. 7, 2003

(30) Foreign Application Priority Data
Oct. 7, 2002 (FR) 0212409

(51) Int. Cl. F16L 11/00

(52) U.S. Cl. 138/137; 138/141

(57) ABSTRACT

A hose for conveying a fluid containing hydrogen, the hose being comprising, from the inside towards the outside:

a layer comprising a fluorine-based thermoplastic material;

a layer comprising a vinyl ethylene alcohol; and

a layer comprising a polybutylene terephthalate.

### BACKGROUND OF THE INVENTION

The environmental constraints applicable to the field of transport have led manufacturers to seek new ways of powering motor vehicles. Of these new ways, electrical power seems to be the simplest to implement, but it raises a problem of how to store electrical energy on board the vehicle. Present storage batteries are relatively heavy and bulky and are capable of storing energy sufficient for a range of only about 100 kilometers.

Proposals have therefore been made to replace conventional storage batteries with a fuel cell. A fuel cell operates on the principle of reverse electrolysis. A fuel, generally hydrogen, and an oxidizer, generally oxygen, are associated to perform a chemical reaction that produces electricity. Hydrogen is then stored under pressure in a tank on board the vehicle. It is also possible to produce hydrogen on the vehicle by reforming a hydrocarbon contained under pressure in a tank on board the vehicle.

The hydrogen or the mixture of gases containing hydrogen produced by the reforming is transferred by means of pipes made of steel so as to be capable of withstanding high temperatures (100° C. or higher) and relatively high pressures (about 5 bars). Steel also presents the advantage of being substantially inert relative to hydrogen, thus making it possible to avoid the pipe decomposing into the gas and polluting and/or giving rise to parasitic secondary reactions with the electrodes of the fuel cell.

Unfortunately, oxygen tends to degrade steel. In addition, steel pipes are relatively heavy, inflexible, and expensive.

### OBJECT OF THE INVENTION

An object of the invention is to provide means for transporting gas that contains hydrogen while remedying the above-mentioned drawbacks.

### BRIEF DESCRIPTION OF THE INVENTION

To this end, the invention provides a hose for transporting a fluid containing hydrogen, and comprising from the inside towards the outside:

a layer comprising a fluorine-based thermoplastic material;

a layer comprising a vinyl ethylene alcohol; and

a layer comprising a polybutylene terephthalate.

The hose made in this way is lighter in weight, more flexible, and less expensive than an equivalent pipe made of steel. In addition, the hose performs a barrier function relative to hydrogen and oxygen.

In this case, the layer of fluorine-based material acts as a hydrogen barrier, whereas such materials are usually employed for their low permeability to alcohols.

The vinylethylene alcohol layer in this structure performs three functions, namely: it serves as a barrier to hydrogen; and it is poorly permeable to oxygen regardless of whether the oxygen comes from outside or inside the hose (in which case the oxygen in question is oxygen contained in the product of reformation).

The layer of polybutylene terephthalate serves in this case firstly to act as a barrier to hydrogen and secondly to perform a function of protecting the hose against external aggression.

Other characteristics and advantages of the invention appear on reading the following description of a particular and non-limiting embodiment of the invention.

### BRIEF DESCRIPTION OF THE DRAWING

Reference is made to the sole accompanying figure which is a cross-section through a hose of the invention.

### DETAILED DESCRIPTION OF THE INVENTION

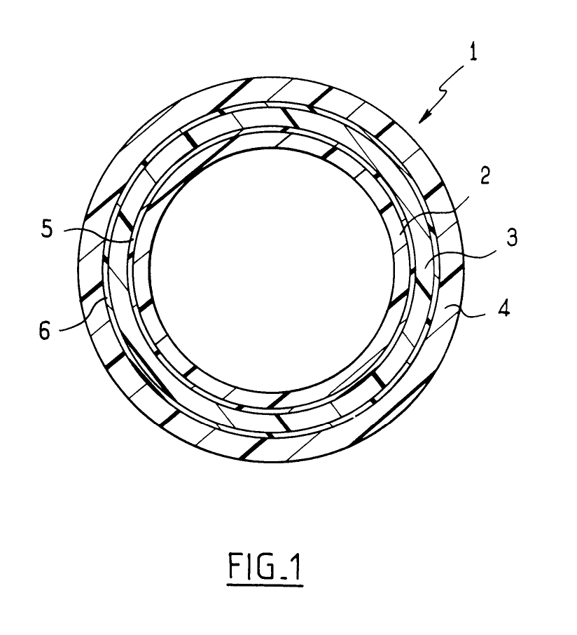

With Reference to FIG. 1, a hose in accordance with the invention, given overall reference 1, comprises an inner layer 2 made of a fluorine-based material, and more particularly in this case polyvinylidene fluoride (PVDF). Other fluorine-based thermoplastic materials can be used, and in particular ethylene fluorinated ethylene propylene (EFEP) or ethylene tetrafluoroethylene (ETFE).

The pipe 1 has an intermediate layer 3 made of ethylene vinyl alcohol (EVOH) and an outer layer 4 of polybutylene terephthalate (PBT).

Between the inner layer 2 and the intermediate layer 3, and between the intermediate layer 3 and the outer layer 4, there are disposed bonding layers 5 and 6 made of adhesive presenting properties of adhesion with the materials constituting the inner layer 2, the intermediate layer 3, and the outer layer 4. In this case, the adhesive used is based on polyurethane.

The hose made in this way is relatively lightweight, flexible, and inexpensive. In addition, this hose provides a barrier function against hydrogen and against oxygen.

Naturally, the invention is not limited to the embodiment described and variant embodiments can be applied thereto without going beyond the scope of the invention as defined by the claims.

In particular, when the materials of the inner, intermediate, and outer layers present properties of sufficient adhesion relative to the adjacent layers, it is possible to omit the bonding layer(s).

What is claimed is:

1. A hose for transporting a fluid containing hydrogen, the hose comprising from the inside towards the outside:
a layer comprising a fluorine-based thermoplastic material;
a layer comprising a vinyl ethylene alcohol; and
a layer comprising a polybutylene terephthalate.

2. A hose according to claim 1, wherein the fluorine-based thermoplastic material is ethylene fluorinated ethylene propylene.

3. A hose according to claim 1, wherein the fluorine-based thermoplastic material is an ethylene tetrafluoroethylene.

4. A hose according to claim 1, wherein the fluorine-based thermoplastic material is a polyvinylidene fluoride.

5. A hose according to claim 1, wherein at least two of the layers are bonded together by an adhesive layer.

6. A hose according to claim 5, wherein the adhesive is based on polyurethane.
